(19) United States
(12) Patent Application Publication
(10) Pub. No.: US 2008/0084360 A1
(43) Pub. Date: Apr. 10, 2008

(54) Display device and method of renewing display

(75) Inventor: Tomohisa Shingai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/882,586

(22) Filed: Aug. 2, 2007

(30) Foreign Application Priority Data
Oct. 5, 2006 (JP) 2006-274370

(51) Int. Cl. G09G 5/00

(52) U.S. Cl. 345/1.3

(57) ABSTRACT

Display panels are located in a predetermined arrangement to form a screen in a display device. A driver circuit is independently attached to each of the display panels in the display device. The driver circuit outputs a driving signal to the display panel in response to the reception of a radio signal. The display changes on the individual display panel in response to the reception of the driving signal. A radio signal is utilized to renew the display. Wiring is not required to extend from the display panel. This results in a simplified structure of the display device.

### BACKGROUND OF THE INVENTION

1. Field of the Invention

The present invention relates to a display device applicable to an advertisement, for example.

2. Description of the Prior Art

A display device is sometimes utilized for a signboard or an advertisement located outdoors. The display device includes light-emitting elements such as light-emitting diodes, LEDs, for example. The light-emitting elements are arranged in a matrix. An electrode is attached to the individual light-emitting element. Awiring is connected to the electrode. A static drive system or a passive matrix drive system is utilized to control the operation of the light-emitting element, for example. This results in display of an image such as a character, graphics, or the like, on the display device.

A wiring is connected to the individual light-emitting element in a conventional display device. The number of joints between the electrodes and the wirings is at least twice the number of the light-emitting elements. This results in a complicated structure of the display device.

### SUMMARY OF THE INVENTION

It is accordingly an object of the present invention to provide a display device of a simplified structure. It is also an object of the present invention to provide a display device unit and a method of renewing display, significantly contributing to realization of such a display device.

According to a first aspect of the present invention, there is provided a display device comprising: display panels located in a predetermined arrangement to form a screen; and driver circuits attached to the display panels, respectively, the driver circuit each outputting a driving signal to a corresponding one of the display panels in response to reception of a radio signal.

The driver circuit is independently attached to each of the display panels in the display device. The driver circuit outputs a driving signal to the display panel in response to the reception of a radio signal. The display panels are located in a predetermined arrangement. The display changes on the individual display panel in response to the reception of the driving signal. Aradio signal is utilized to renew the display. Wiring is not required to extend from the display panel. This results in a simplified structure of the display device.

The display panels each may include a display element having a memory characteristic. Such a display element is designed to keep the current display without supply of electric power. No power source should thus physically be connected to the display device. Wiring is not required to extend from the display device in the same manner as described above. This results in a simplified structure of the display device.

A power supply circuit may be connected to each of the driver circuits to generate a driving power in response to the reception of the radio signal. The driving power for the driver circuit is generated in the display device in response to the reception of a radio signal. No power source should thus physically be connected to the display device. This results in a simplified structure of the display device. The display panel and the driver circuit may be enclosed in an enclosure.

According to a second aspect of the present invention, there is provided a display device unit comprising: a signal transmission device transmitting a radio signal; display panels located in a predetermined arrangement to form a screen; and driver circuits attached to the display panels, respectively, the driver circuit each outputting a driving signal to a corresponding one of the display panels in response to reception of the radio signal.

The radio signal from the signal transmission device is utilized to renew the display on the display panel in the display device unit. No wiring is required between the display panels and the signal transmission device. This results in a simplified structure of the display device unit. Moreover, the signal transmission device is physically separated from the display device. The signal transmission device is only applicable to the display panels in the renewal of the display. This results in reduction of the weight of the display device.

The display panel may include a display element having a memory characteristic. A power supply circuit may individually be connected to each of the driver circuit to generate a driving power in response to the reception of the radio signal. The display panel and the corresponding driver circuit may be enclosed in an enclosure.

The signal transmission device may transmit the radio signal common to the display panels in the display device unit. The signal transmission device is thus allowed to simultaneously transmit radio signals to all the display panels. In this case, the radio signals may be synchronized with one another. This results in avoidance of interference between the radio signals. Predetermined information may be extracted from the radio signals in the display device.

According to a third aspect of the present invention, there is provided a method of renewing display, comprising transmitting radio signals to display panels from a signal transmission device to renew the displays on the display panels, the display panels being located in a predetermined arrangement at positions opposed to the signal transmission device.

The radio signal from the signal transmission device is utilized to renew the display on the display panel. No wiring is required between the display panel and the signal transmission device. This results in a simplified structure of the display panel. This method greatly contributes to realization of the aforementioned display device. Moreover, the signal transmission device is physically separated from the display panel. The signal transmission device is only applicable to the display panels in the renewal of the display. This results in reduction of the weight of the display panels.

Here, the signal transmission device may transmit the radio signal common to the display panels in the aforementioned manner. The radio signals may be synchronized with one another.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a side view schematically illustrating a truck as a specific example of an advertising medium;

FIG. 2 is a plan view schematically illustrating a display panel according to a specific example;

FIG. 3 is an exploded view schematically illustrating the display panel;

FIG. 4 is a block diagram schematically illustrating the structure of the display panel;

FIG. 5 is a sectional view schematically illustrating a display element according to a specific example;

FIG. 6 is a plan view schematically illustrating the display element;

FIG. 7 is a side view schematically illustrating a signal transmission device according to a specific example;

FIG. 8 is a block diagram schematically illustrating the structure of the signal transmission device;

FIG. 9 is a side view schematically illustrating an airship as another specific example of an advertising medium;

FIG. 10 is a side view schematically illustrating a signal transmission device according to another specific example;

FIG. 11 is a sectional view schematically illustrating the signal transmission device; and

FIG. 12 is an exploded view schematically illustrating a display panel according to another specific example.

### DESCRIPTION OF THE PREFERRED EMBODIMENTS

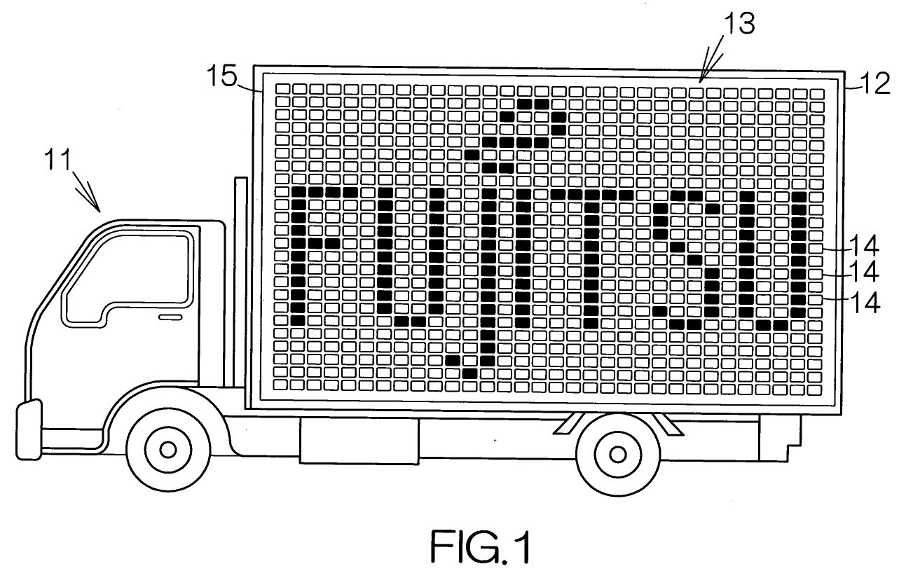

FIG. 1 schematically illustrates a truck 11 as a specific example of an advertising medium. The truck 11 has a carrier 12. A display device 13 is fixed to the carrier 12. The display device 13 includes a group of display panels 14. The display panels 14 may be fixed on a support member 15 in the shape of a flat plate, for example. The support member 15 is fixed to the carrier 12. The display panels 14 are arranged in a matrix to form a screen on the support member 15, for example. Here, the display panels 14 are arranged in 24 rows and 32 columns, for example. The individual display panel 14 provides one pixel in the screen of the display device 13. The display on the display panels 14 forms a character, graphics, or the like, on the screen of the display device 13.

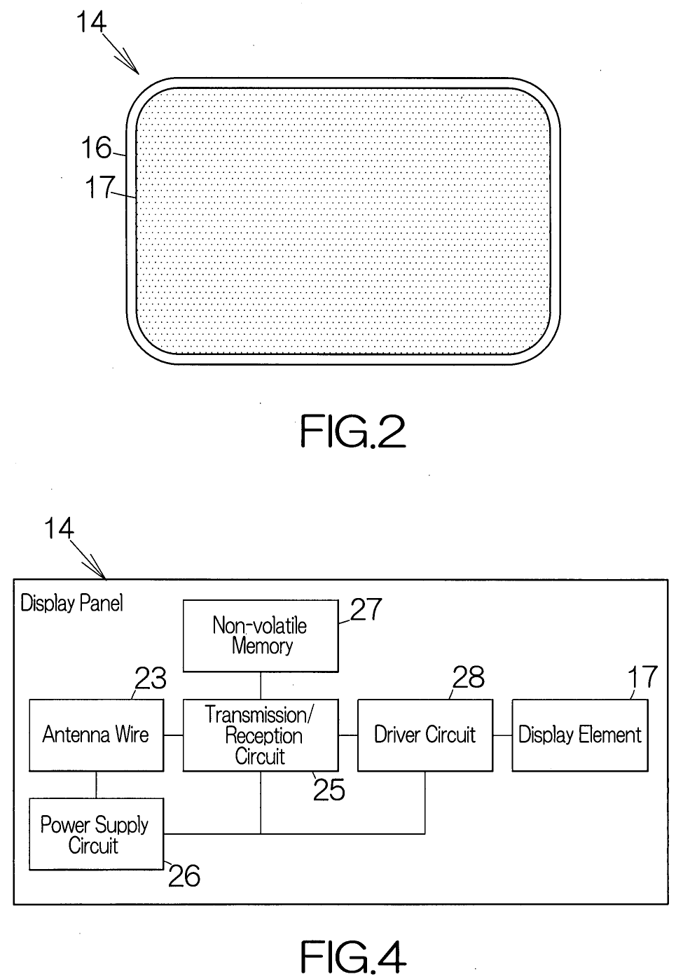

As shown in FIG. 2, the individual display panel 14 is RFID (Radio Frequency Identification) in the shape of a card, for example. The display panel 14 includes a thin enclosure 16. A rectangular display element 17 is, for example, enclosed in the enclosure 16. The display element 17 has a uniform color. The color is chosen from 4,096 colors, for example. A display element having a non-volatile memory characteristic is utilized as the display element 17. The display element 17 may be made of a cholesteric liquid crystal panel, for example. The display element 17 of this type is allowed to semipermanently keep display of the uniform color without receiving electric power. The display element 17 will be described later in detail.

As shown in FIG. 3, the enclosure 16 includes a pair of covers 18, 18 made of resin. The covers 18 may be made of a transparent polyethylene terephthalate (PET) film, for example. The display element 17 and a film substrate 19 are interposed between the covers 18, 18. The film substrate 19 is superposed on the back surface of the display element 17, for example. The display element 17 and the film substrate 19 are in this manner placed within the closed space established between the covers 18. Even if the display panel 14 gets wet because of rain, for example, the display element 17 and the film substrate 19 can be prevented from getting wet.

An IC (integrated circuit) chip 21 and a driver chip 22 are mounted on the film substrate 19. The driver chip 22 is connected to the IC chip 21. The aforementioned display element 17 is connected to the driver chip 22. An antenna wire 23 is coupled to the IC chip 21. The antenna wire 23 is embedded within the film substrate 19, for example. The antenna wire 23 is designed to receive radio waves or a radio signal. The received radio signal is supplied to the IC chip 21.

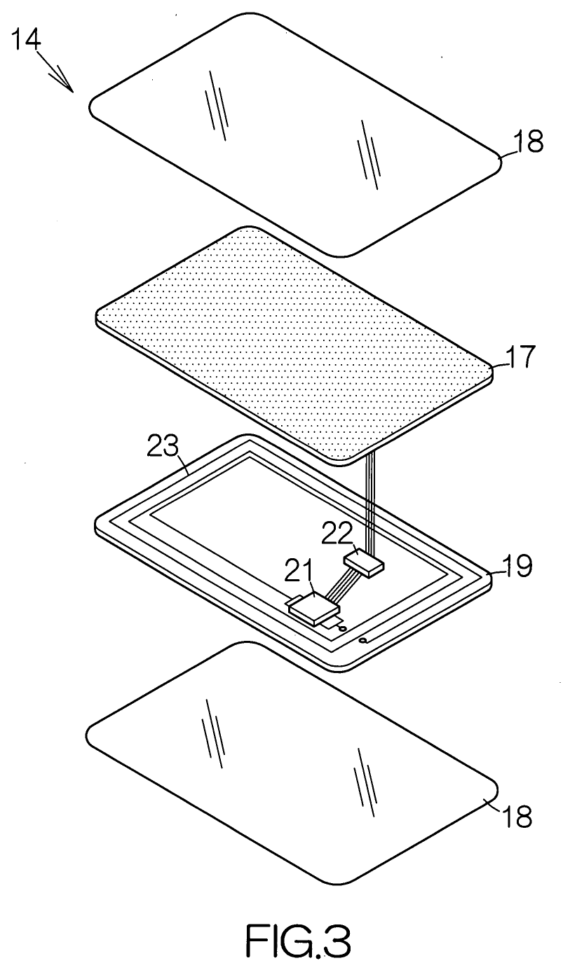

As shown in FIG. 4, the IC chip 21 includes a radio transmission/reception circuit 25, a power supply circuit 26 and a non-volatile memory 27 incorporated in the IC chip 21, for example. The power supply circuit 26 is connected to the antenna wire 23. The power supply circuit 26 is designed to generate electric power in response to the reception of a radio signal at the antenna wire 23. The power supply circuit 26 is also connected to the transmission/reception circuit 25. The electric power is supplied to the transmission/reception circuit 25. The transmission/reception circuit 25 is connected to the antenna wire 23. The transmission/reception circuit 25 is in this manner allowed to transmit a radio signal through the antenna wire 23.

Positional information of the display panel 14 is stored in the non-volatile memory 27. The positional information may include the numbers of the row and column specifying the location of the display panel 14 within the screen, for example. The uppermost row in the vertical direction of the truck 11 is defined as the first row for the count of the number of the rows, for example. The front end column in the longitudinal direction of the truck 11 is defined as the first column for the count of the number of the columns, for example. The information stored in the non-volatile memory 27 is transmitted from the antenna wire 23 through the transmission/reception circuit 25.

A driver circuit 28 is incorporated in the driver chip 22. The driver circuit 28 is connected to the transmission/reception circuit 25 and the power supply circuit 26 of the IC chip 21. The driver circuit 28 is also connected to the display element 17. The driver circuit 28 is designed to receive electric power from the power supply circuit 26. The driver circuit 28 outputs a driving signal to the display element 17 in response to the reception of the radio signal output from the transmission/reception circuit 25. The driving signal specifies color displayed on the display element l7. The display element 17 displays a specific color in accordance with the received driving signal.

The driver circuit 28 serves to pass the electric power to the display element 17. The display element 17 is designed to change the color in response to the supplied electric power. The power supply circuit 26 in this manner serves as a power supply for both the transmission/reception circuit 25 and the driver circuit 28 or display element 17. The transmission/reception circuit 25 is designed to receive voltage of a relatively lower level. To the contrary, the display element 17 is designed to receive voltage of a relatively higher level. Specifically, the power supply circuit 26 is capable of supplying voltage of difference levels.

Next, description will be made on the structure of the display element 17. As shown in FIG. 5, the display element 17 includes first, second and third liquid crystal layers 31, 32, 33. The first, second and third liquid crystal layers 31, 32, 33 are superposed on one another in this sequence. The first liquid crystal layer 31 displays red. The second liquid crystal layer 32 displays green. The third liquid crystal layer 33 displays blue. Each of the liquid crystal layers 31, 32, 33 is interposed between a pair of transparent substrates 34, 35. The transparent substrates 34, 35 are made of a transparent resin material, for example. Transparent electrodes 36, 37 are respectively formed on the opposed surfaces of the transparent substrates 34, 35. Indium tin oxide (ITO) may be utilized to form the transparent electrodes 36, 37.

The transparent substrate 35 of the third liquid crystal layer 33 is bonded to the transparent substrate 34 of the second liquid crystal layer 32. The transparent substrate 35 of the second liquid crystal layer 32 is bonded to the transparent substrate 34 of the first liquid crystal layer 31. Each of the liquid crystal layers 31, 32, 33 is sealed between the transparent electrodes 36, 37. Sealants 38 are utilized to seal the liquid crystal layer 31, 32, 33. The cholesteric liquid crystal is in this manner sealed within a closed space. The lower transparent substrate 35 of the first liquid crystal layer 31 is received on a light absorbing layer 39 colored black. The light absorbing layer 39 is designed to absorb light led into the display element 17.

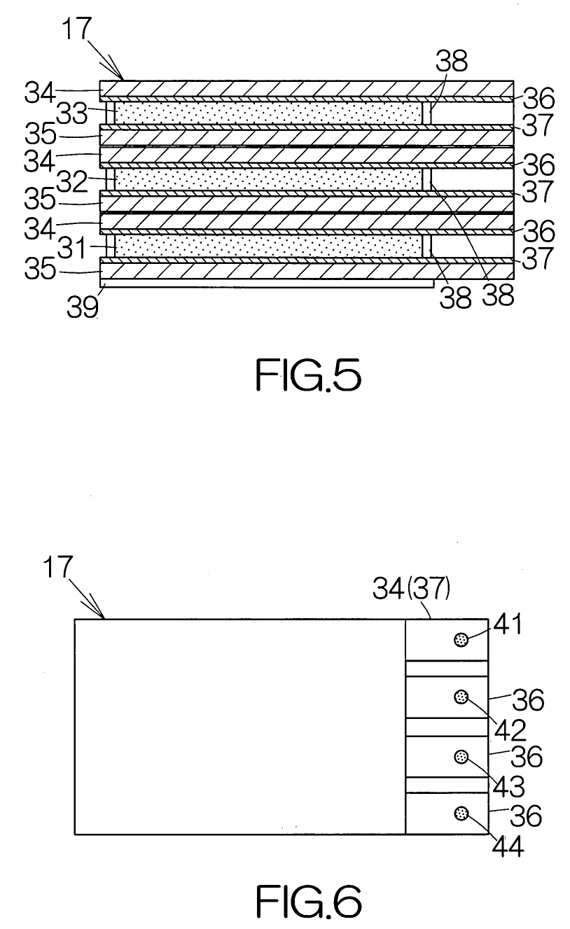

The transparent substrates 34, 35 and the transparent electrodes 36, 37 are contoured outside the contours of the liquid crystal layers 31, 32, 33. As shown in FIG. 6, the lower transparent electrodes 37, 37, 37 are connected to a through hole 41. The upper transparent electrodes 36, 36, 36 are connected to through holes 42, 43, 44, respectively.

A predetermined voltage is applied to the transparent electrodes 36, 37 in the display element 17. The orientation of liquid crystal molecules changes in the liquid crystal layers 31, 32, 33 in response to the supply of the voltage. Even after the supply of the voltage has been stopped, the liquid crystal molecules are kept in a predetermined orientation. The orientation of the liquid crystal molecules is utilized to control the reflection of light led into each of the liquid crystal layers 31, 32, 33. A predetermined color is in this manner displayed on the display element 17 based on the degree of the reflection.

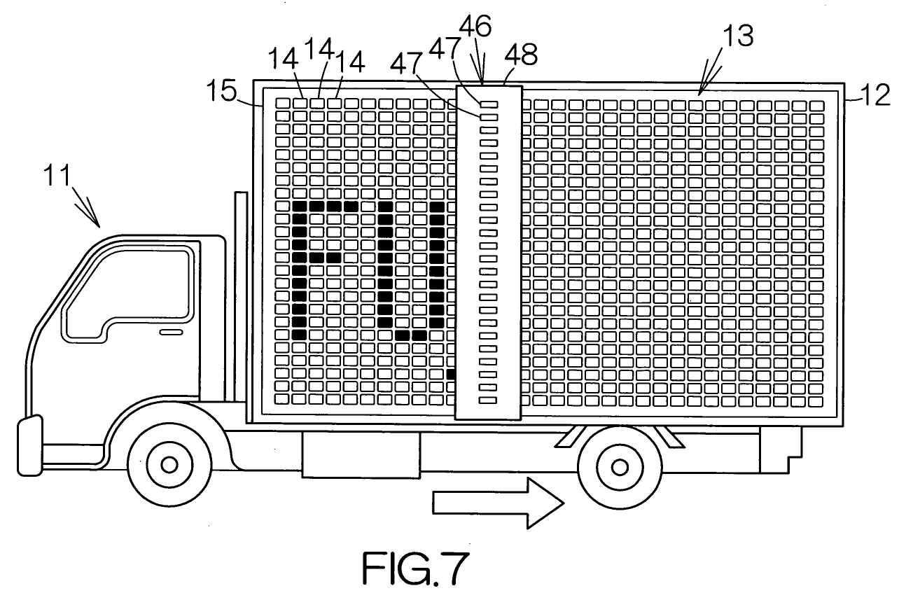

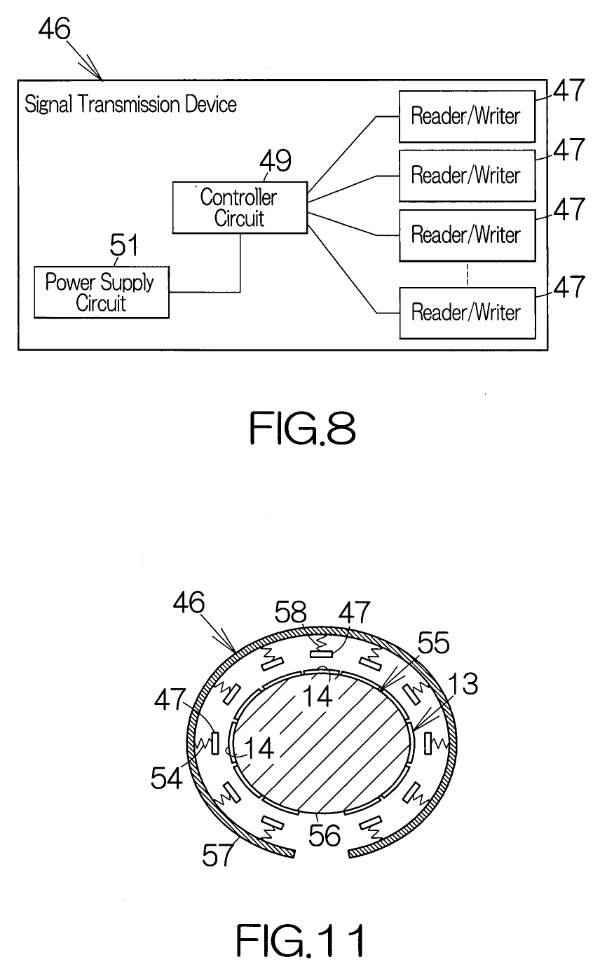

As shown in FIG. 7, a signal transmission device 46 is utilized to change the color of the individual display panel 14. The signal transmission device 46 includes readers/writers 47. The number of the readers/writers 47 is equal to the number of the display panels 14 in one column. The interval between the adjacent ones of the readers/writers 47 is equal to the interval between the adjacent ones of the display panels 14. The readers/writers 47 are supported on a transport mechanism 48. The transport mechanism 48 is designed to move in the horizontal direction along the longitudinal direction of the truck 11. A predetermined distance may be kept between the readers/writers 47 and the display panels 14 during the horizontal movement of the transport mechanism 48. The predetermined distance may depend on the communication range of a radio signal.

As shown in FIG. 8, the signal transmission device 46 includes a controller circuit 49 and a power supply circuit 51. The power supply circuit 51 is designed to supply electric power to the controller circuit 49. The controller circuit 49 is connected to the individual reader/writer 47. The controller circuit 49 is designed to output a control signal to the individual reader/writer 47. The control signal specifies color of the corresponding display panel 14. The individual reader/writer 47 generates a radio signal based on the control signal. The generated control signal is transmitted to the display panel 14. It should be noted that the display device 13 and the signal transmission device 46 in combination serve as a display device unit according to the present invention.

Next, a brief description will be made on a method of renewing the display on the display device 13. The controller circuit 49 generates a control signal for the display panels 14 in each of the columns. The control signal includes positional information and color information. The positional information specifies the position of the individual display panel 14 in each of the column. The positional information includes the numbers of the row and column specifying the location of the individual display panel 14. The color information specifies color for the individual display panel 14 identified in the positional information. The individual reader/writer 47 generates the radio signal based on the control signal generated for each of the column.

The transport mechanism 48 brings the signal transmission device 46 at a position corresponding to the front end column in the screen. Authentication processing is executed between the readers/writers 47 and the corresponding display panels 14 prior to the transmission of the aforementioned radio signal. Predetermined information is exchanged between the readers/writers 47 and the corresponding display panels 14, respectively. After the authentication has been completed, all the readers/writers 47 simultaneously transmit the radio signals to the display panels 14 in the front end column. The radio signal may be transmitted in the form of a packet, for example.

The individual display panel 14 receives the radio signal through the antenna wire 23. The power supply circuit 26 generates electric power in response to the reception of the radio signal. The generated electric power is supplied to the driver circuit 28. When the transmission/reception circuit 25 receives the control signal, the positional information contained in the radio signal is compared with the positional information stored in the non-volatile memory 27. The transmission/reception circuit 25 extracts the color information of the position specified in the positional information stored in the non-volatile memory 27. The color information is supplied to the driver circuit 28.

The driver circuit 28 generates the driving signal based on the color information. The driving signal specifies color for the display element 17. The driving signal enables application of a predetermined voltage to the transparent electrodes 36, 37 of the display element 17. The orientation of the liquid crystal molecules changes in the liquid crystal layers 31, 32, 33 in response to the supply of the voltage. The liquid crystal molecules are kept in a predetermined orientation even after the supply of the voltage has been stopped. Display of a predetermined color is established on the individual display element 17 in the front end column.

The transport mechanism 48 then brings the signal transmission device 46 at a position corresponding to the second column next to the front end column. Authentication processing is executed between the readers/writers 47 and the corresponding display panels 14. All the readers/writers 47 simultaneously transmit the radio signals to the display panels 14 in the second column. The same processing is repeated for the third column, the fourth column, and the subsequent columns. Display of a predetermined color is in this manner established on the individual display element 14 in all the columns. A predetermined character or graphic appears on the display device 13. The display is renewed on the display device 13 in this manner.

The display device 13 enables exchange of radio signals between the display panels 14 and the readers/writers 47. A predetermined color is displayed on the individual display element 17 in response to the reception of the radio signal. Utilization of the radio signal in the renewal of the display on the display device 13 serves to eliminate wirings between the display panels 14 and the signal transmission device 46 as well as between the display panels 14. This leads to a simplified structure of the display device 13.

Moreover, the display device 13 and the signal transmission device 46 are physically separated from each other. The signal transmission device 46 is utilized only for the renewal of the display. The weight of the display device 13 can thus be reduced. In addition, the display element 17 and the film substrate 19 are sealed within a closed space established between the covers 18, 18 in the individual display panel 14. Since no wiring is required as described above, an opening or a joint for wiring can be eliminated in the covers 18, 18 or enclosure 16. The display element 17 and the film substrate 19 are thus reliably prevented from getting wet.

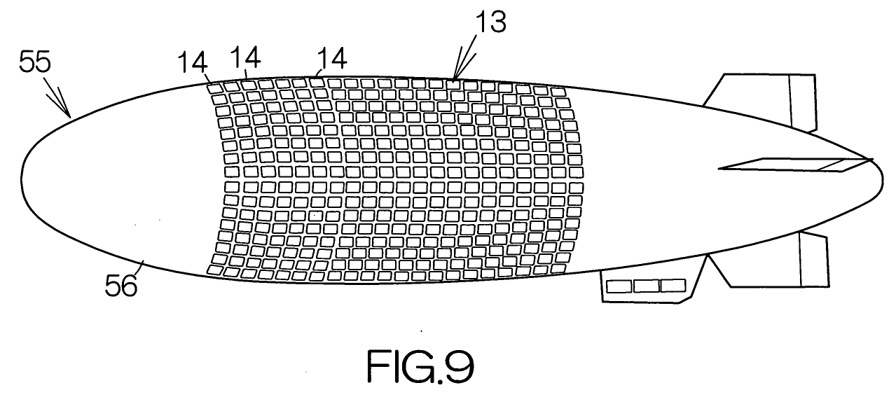

FIG. 9 schematically illustrates an airship 55 as another specific example of an advertising medium. The display device 13 is fixed to the surface of the airship 55. The display device 13 includes a group of the display panels 14. The airship 55 includes a spindle-shaped main body 56, for example. The display panels 14 are arranged in a matrix to form a screen on the curved surface of the main body 56. The display panels 14 are arranged in 240 rows and 320 columns, for example. Since the main body 56 has different diameters in the longitudinal direction of the airship 55, the display panels 14 in different columns may have different dimensions.

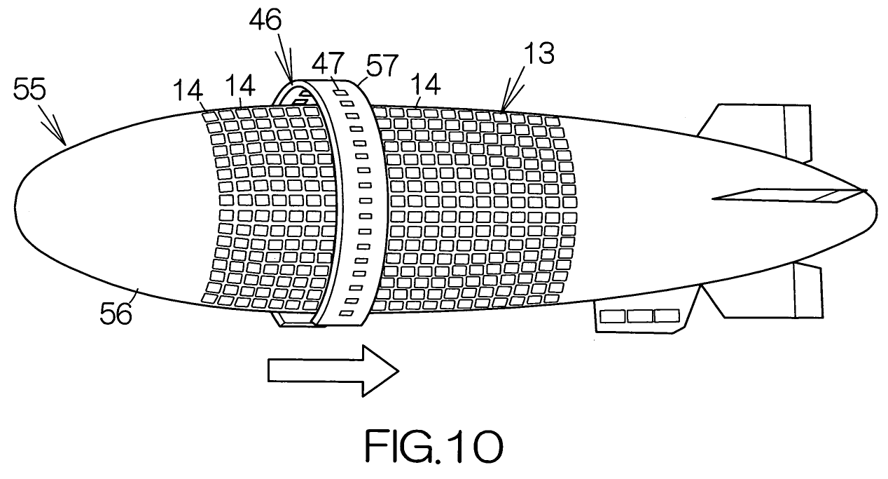

As shown in FIG. 10, the aforementioned signal transmission device 46 is utilized to change the color of the display panels 14. The number of the readers/writers 47 may be equal to the number of the display panels 14 in one column. The interval between the adjacent ones of the readers/writers 47 is equal to the interval between the adjacent ones of the display panels 14. The readers/writers 47 are supported on a transport mechanism 57. The transport mechanism 57 surrounds the main body 56 in the circumferential direction of the main body 56. The transport mechanism 57 is designed to move in the horizontal direction along the longitudinal direction of the airship 55. The transport mechanism 57 serves to position the signal transmission device 46 relative to the display device 13.

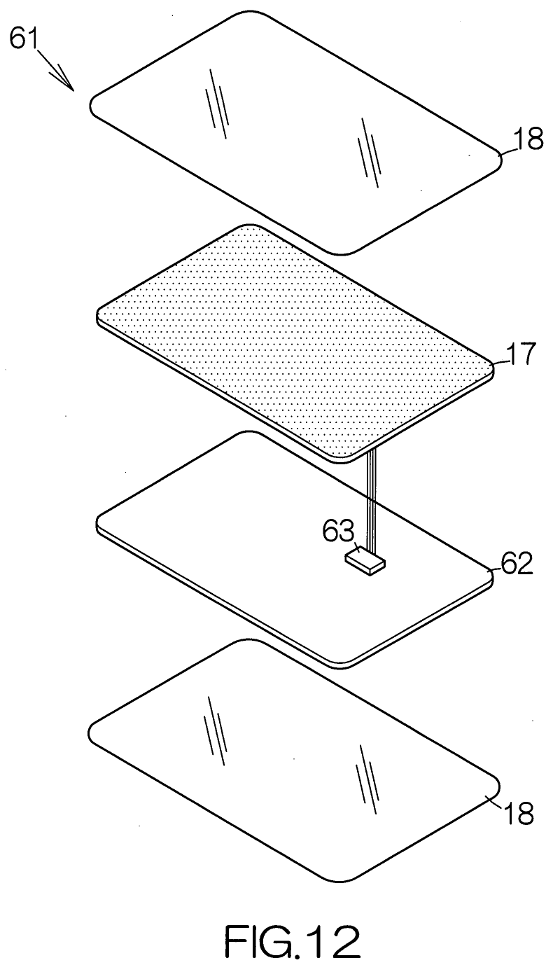

As shown in FIG. 11, the transport mechanism 57 includes distance control mechanisms 58. The distance control mechanisms 58 are related to the readers/writers 47, respectively. The distance control mechanism 58 forces the reader/writer 47 to get closer to/distanced from the corresponding display panel 14. The distance control mechanism 58 may utilize a ball screw, for example. When the electric field intensity is weak between the reader/writer 47 and the corresponding display panel 14, for example, the reader/writer 47 is forced to get closer to the display panel l4. When the electric field intensity is strong, the reader/writer 47 is forced to get distanced from the display panel 14. Like reference numerals are attached to the structure or components equivalent to the aforementioned ones.

The controller circuit 49 generates a control signal for the display panels 14 in a column for the renewal of the display on the display device 13 in the same manner as described above. The individual reader/writer 47 generates a radio signal based on the control signal. The transport mechanism 57 brings the signal transmission device 46 at a position corresponding to the front end column of the display panels 14 in the screen. The distances are adjusted between the readers/writers 47 and the display panels 14. The readers/writers 47 then simultaneously transmit the radio signals to the display panels 14 in the front end column. Display of a predetermined color is established on the individual display element 17 in the front end column in the same manner as described above.

The transport mechanism 57 then brings the signal transmission device 46 at a position corresponding to the second column of the display panels 14. Since the main body 56 has different diameters in the longitudinal direction of the airship 55, the distances change between the readers/writers 47 and the display panels 14 in response to shift between the columns. Accordingly, the distances are adjusted in response to shift between the columns. The readers/writers 47 simultaneously transmits the radio signals to the display panels 14 in the second column. The same processing is repeated for the third column, the fourth column, and the subsequent columns. Display of a predetermined color is in this manner established on the individual display element 14 in all the columns. A predetermined character or graphic appears on the display device 13.

A reference clock may be input into the individual reader/writer 47 from the controller circuit 49 in the signal transmission device 46 prior to the transmission of the radio signals from the readers/writers 47. The operating clock of the readers/writers 47 is thus synchronized with the reference clock. The phases of the radio signals are in this manner aligned with each other in all the readers/writers 47. The transmission of the radio signals is synchronized with one another. The radio signals are transmitted from the readers/writers 47 at the same time point. This results in avoidance of interference between the radio signals of the adjacent readers/writers 47, for example.

The signal transmission device 46 may allow generation of the radio signals at the controller circuit 49. The generated radio signals may be distributed to the respective readers/writers 47. The readers/writers 47 are reliably prevented from a shift in the timing for generation of the radio signals. The transmission of the radio signals is synchronized with one another. The radio signals are transmitted from the readers/writers 47 at the same time point. This results in avoidance of interference between the radio signals of the adjacent readers/writers 47, for example.

As shown in FIG. 12, a display panel 61 may be utilized in place of the aforementioned display panel 14 in the display device 13. The IC chip 21 and the antenna wire 23 may be omitted from a film substrate 62 in the display panel 61. An antenna coil may be incorporated in a driver chip 63. The antenna coil may receive a radio signal. Likewise, a power supply circuit and a non-volatile memory may be incorporated in the driver ship 63. The film substrate 62 is allowed to in this manner enjoy a simplified structure.

The display panel 14 or display element 17 can take any shape or form different from the described one. The display panel 14 may take the shape of a circle, a triangle, a parallelogram, or the like. Likewise, the dimension of the display panel 14 or display element 17 may be changed depending on the resolution of the display element 17.

What is claimed is:

1. A display device comprising:
display panels located in a predetermined arrangement to form a screen; and
driver circuits attached to the display panels, respectively, the driver circuits each outputting a driving signal to a corresponding one of the display panels in response to reception of a radio signal.

2. The display device according to claim 1, wherein the display panels each includes a display element having a non-volatile memory characteristic.

3. The display device according to claim 1, wherein a power supply circuit is connected to each of the driver circuits to generate a driving power in response to reception of the radio signal.

4. The display device according to claim 1, wherein each of the display panels and the corresponding one of the driver circuits are enclosed in an enclosure.

5. A display device unit comprising:
a signal transmission device transmitting a radio signal;
display panels located in a predetermined arrangement to form a screen; and
driver circuits attached to the display panels, respectively, the driver circuits each outputting a driving signal to a corresponding one of the display panels in response to reception of the radio signal.

6. The display device unit according to claim 5, wherein the display panels each includes a display element having a non-volatile memory characteristic.

7. The display device unit according to claim 5, wherein a power supply circuit is connected to each of the driver circuits to generate a driving power in response to reception of the radio signal.

8. The display device unit according to claim 5, wherein each of the display panels and the corresponding one of the driver circuits are enclosed in an enclosure.

9. The display device unit according to claim 5, wherein the signal transmission device transmits the radio signal common to the display panels.

10. The display device unit according to claim 9, wherein transmission of the radio signal is synchronized with one another for the display panels.

11. A method of renewing display, comprising transmitting radio signals to display panels from a signal transmission device to renew the displays on the display panels, the display panels being located in a predetermined arrangement at positions opposed to the signal transmission device.

12. The method according to claim 11, wherein the radio transmission device transmits the radio signal common to the display panels.

13. The method according to claim 12, wherein transmission of the radio signal is synchronized with one another for the display panels.
